(19) United States
(12) Patent Application Publication
(10) Pub. No.: US 2025/0180094 A1
(43) Pub. Date: Jun. 5, 2025

(54) PASSIVE STABILIZATION SYSTEM WITH A LINEAR DISPLACEMENT SUBSYSTEM FOR PAYLOAD ORIENTATION RETENTION

(71) Applicant: ELBIT SYSTEMS ELECTRO-OPTICS - ELOP LTD., Rehovot (IL)

(72) Inventors: Israel LASKER, Rehovot (IL); Daniel HOLLAENDER, Rehovot (IL); Michael GABLIN, Rehovot (IL); Shay Faibish VIGDOR, Rehovot (IL); Roni TZUBERY, Rehovot (IL); Yair SOFFAIR, Rehovot (IL)

(21) Appl. No.: 19/046,572

(22) Filed: Feb. 6, 2025

Related U.S. Application Data
(63) Continuation of application No. PCT/IL2023/050845, filed on Aug. 13, 2023.

(30) Foreign Application Priority Data
Aug. 22, 2022 (IL) 295833

(51) Int. Cl. F16F 15/02

(52) U.S. Cl. CPC F16F 15/02

(57) ABSTRACT

A passive stabilization system (PSS) for stabilizing a payload being carried by a carrier, the PSS nay include a linear displacement subsystem (LDS), fixedly connectable to the carrier at one side thereof and fixedly connectable to a payload at another side thereof, such that the LDS is located between the payload and the carrier. The LDS may be configured to enable a three-dimensional (3D) linear displacement of the payload in respect to the carrier, for reducing responsive relative angular movements of the payload in respect to the carrier, for maintaining a stable relative angular orientation of the payload in respect to the carrier.

### FIELD OF THE INVENTION

The present invention relates in general to the field of stabilization systems and methods. In particular, the present invention relates to passive stabilization systems and methods that enable orientation retention of a payload being mounted to or carried by a moveable carrier.

### BACKGROUND

Passive damping devices or elements located between two objects are often used to absorb oscillatory movements and/or shocks emanating from one of the objects, for preventing the forces exerted by the vibrating/moving object from affecting the other object to be vibration-isolated.

The term “passive damping” typically pertains to damping that is not controllable i.e., to cases in which the damping is done as a natural response to forces applied.

Typical passive damping devices/systems include one or more dampers made of elastic materials or elements such as springs, rubber elements, sponge elements etc. That can naturally absorb mechanical forces/oscillations/vibrations/accelerations/shocks by way of energy dissipation.

In some cases, the damping may cause undesired and uncontrollable relative angular movements of the isolated object in respect to the oscillating/moving carrier. This effect is enhanced especially in cases in which the damping center of the damping system/devices is not aligned with, is external to and/or is remotely located from a center of mass of the isolated object.

When the isolated object is a payload that includes motion-sensitive equipment such as optical, electro-optical and/or launching equipment, any change in the payload's angular orientation in respect to a movable carrier, carrying the payload, can lead to dramatic impairing of the performances of the payload equipment and may prevent it from functioning in a reliable manner.

### SUMMARY

Aspects of disclosed embodiments pertain to a passive stabilization system (PSS) for stabilizing a payload being carried by a carrier, the PSS comprising at least a linear displacement subsystem (LDS), fixedly connectable to the carrier at one side thereof and fixedly connectable to a payload at another side thereof, such that the LDS is located between the payload and the carrier, wherein the LDS is configured to enable a three dimensional (3D) linear displacement of the payload in respect to the carrier, for preventing/reducing/minimizing responsive relative angular movement of the payload in respect to the carrier, for maintaining a stable relative angular orientation of the payload in respect to the carrier.

Other aspects of disclosed embodiments pertain to a method for stabilizing a payload carried by a carrier, the method comprising at least:
providing a PSS comprising at least a linear displacement subsystem (LDS) and at least one damping subsystem, wherein the LDS is configured to enable three dimensional (3D) linear displacement of the payload;
connecting the PSS at one side thereof to the carrier and at another side thereof to a payload, such that the PSS is located between the carrier and the payload;
damping movements of the carrier by the at least one damping subsystem; and
reducing rotation of the payload in respect to the carrier by using the LDS.

Aspects of disclosed embodiments further pertain to a passive stabilization system (PSS) for stabilizing a payload carried by a carrier, the system comprising at least:
a linear displacement subsystem (LDS), fixedly connectable to the carrier at one side thereof and fixedly connectable to a payload at another side thereof, such that the LDS is located between the payload and the carrier; and
a damping subsystem comprising one or more dampers, wherein the damping subsystem is located and configured to damp movements of the carrier and the LDS is configured to prevent/reduce/minimize angular movements of the payload in respect to the carrier by enabling only three-dimensional (3D) linear displacements of the payload in respect to the carrier, for maintaining a stable relative angular orientation of the payload in respect to the carrier.

### BRIEF DESCRIPTION OF DRAWINGS

For a better understanding of various embodiments of the invention and to show how the same may be carried into effect, reference will now be made, by way of example, to the accompanying drawings, in which:

FIGS. 1A-1D show a schematic illustration of a passive stabilization system for (PSS) that includes a linear displacement subsystem and a damping subsystem, according to some embodiments: FIG. 1A is an assembled frontal view of the PSS, when in a fully folded state; FIG. 1B shows the PSS connected to a payload requiring maintaining a required payload orientation for maintaining a corresponding required payload line of sight orientation, when the PSS is in an unfolded state; FIG. 1C is a cross-sectional isometric view of the PSS; and FIG. 1D is an exploded view of some parts of the PSS showing how parts of the linear displacement subsystem are located in respect to other parts of the damping subsystem of the PSS.

FIGS. 2A-2B show cross sectional views of one or both of second displacement assemblies of the linear displacement subsystem of the PSS: FIG. 2A is a cross sectional side view of the two parallel second displacement assemblies; and FIG. 2B is an enlarged view of one of the second displacement assemblies.

FIG. 3 shows a schematic illustration of the damping subsystem for a PSS, according to some embodiments of the PSS, according to some embodiments.

FIG. 4 is a flowchart illustrating steps of a process of passive conversion of carrier's movements, using a PSS that includes both linear displacement and damping means, according to some embodiments.

Structural details of the invention are shown to provide a fundamental understanding of the invention, the description, taken with the drawings, making apparent to those skilled in the art how the several forms of the invention may be embodied in practice.

### DETAILED DESCRIPTION OF EMBODIMENTS

Aspects of disclosed embodiments pertain to a passive stabilization system (PSS) for stabilizing a payload being carried by a carrier, the PSS comprising at least a linear displacement subsystem (LDS), fixedly connectable to the carrier at one side thereof and fixedly connectable to the payload at another side thereof, such that the LDS is located between the payload and the carrier. The LDS may be configured to enable three dimensional (3D) linear displacements of the payload in respect to the carrier, for reducing/preventing/minimizing responsive relative angular movement of the payload in respect to the carrier, for maintaining a stable relative angular orientation of the payload in respect to the carrier.

According to some embodiments, the LDS may be designed to

reduce/prevent/minimize rotational movement of the payload in respect to the carrier, and allow linear displacement of the payload, therefore maintaining a stable relative orientation of the payload.

The term “payload” may refer to any object being loaded to and/or carried by the carrier requiring stabilization. In some cases, the payload may include a casing and equipment, encased by the payload casing that requires stabilization.

The term “stabilization” may pertain to orientation retention during vibration and/or shocks.

The term 3D linear displacement may pertain to causing the payload positioned at an initial X0Y0Z0 position in a predefined PSS coordinate system to be displaced to a new position X1Y1Z1 in that PSS coordinate system, where X1 may be equal to or different from X0, Y1 may be equal to or different from Y0, and Z1 may be equal to or different from Z0 depending on force vectors applied over the LDS.

According to some embodiments, the LDS may enable 3D payload displacement by only allowing linear movements per-axis separate linear, in parallel to each of three different axes X, Y and Z, which may be orthogonal to one another.

The carrier may be for example, a motorized machine, a moving vehicle or vessel, or a device/object/machine/apparatus/facility carried by the vehicle/machine, where the carrier can vibrate, move, tilt, swing, rotate, and/or shake in response to its motorized activity and/or in response to external forces that are applied thereover, therefore requiring high payload stabilization efficiency and efficient payload-orientation retention.

The terms “angular positioning”, “relative angular orientation” “angular orientation” and “payload orientation/positioning” may be used interchangeably herein and may pertain to the angular positioning of the payload or part thereof in respect to the carrier or part thereof, i.e., the angle of tilting between the payload/part of the payload and the carrier/part of the carrier and to the relative rotational position between the payload and the carrier or any parts thereof.

Aspects of disclosed embodiments pertain to a linear displacement subsystem (LDS) for maintaining a stable angular orientation of a payload in respect to a carrier, especially yet not exclusively for systems that also include one or more passive damping devices or elements.

According to some embodiments, the LDS may be fixedly connectable to the carrier at one side thereof and fixedly connectable to a payload base of the payload at another side thereof, such that the LDS is located between the payload and the carrier. The LDS may be configured to enable only linear movement of the payload base (and therefore of the payload) separately in parallel to each one of three linear orthogonal axes, for improving orientation retention of the payload in respect to the carrier.

According to some embodiments, the payload may include motion-sensitive equipment such as optical, electro-optical and/or launching equipment, and the carrier may exert and/or be subjected to forces/oscillations/vibrations/accelerations/shocks requiring payload vibration isolation as well as efficient payload orientation retention e.g., for maintain a stable line of sight (LOS) direction of the payload equipment or part thereof.

According to some embodiments, there is provided a PSS that may include at least:
(i) a first connecting structure such as a first plate; designed to fixedly connect to a base of the payload;
(ii) a second connecting structure such as a second plate; designed to fixedly connect to the carrier;
(iii) a LDS, connectable to the second connecting structure at one side thereof and connectable to the first connecting structure at another side thereof, such that the LDS is located between the two connecting structures; and
(iv) a damping subsystem including, for example, one or more dampers, which may be located between the two plates, for damping/absorbing most of the carrier's movements/vibrations/shocks, while the LDS is used for preventing/reducing/minimizing relative angular (rotational and/or tilting) movement of the payload in respect to the carrier (for maintaining a stable initial/required relative payload-carrier angular position/orientation).

When a payload in connected to a carrier via only damping subsystem, without LDS, significant angular/rotational movements of the payload occur in respect to the carrier. Therefore, in these cases the LDS is used for preventing/reducing angular/rotational movement of the payload in respect to the carrier and enables maintaining a stable (desired) relative angular orientation of the payload in respect to the carrier even when the carrier exerts forces/oscillations/vibrations/accelerations/shocks over the PSS and also in cases in which the center of damping is not aligned with, remote from and/or external to the payload's center of mass (COM).

The PSS of disclosed embodiments, may be able to provide and maintain high payload tilt prevention as well as high oscillation isolation efficiency (herein also referred to as “payload stabilization efficiency”), also in challenging conditions/circumstances such as in cases in which:
(i) the payload is sensitive in terms of payload operation performances (such as optical equipment requiring maintaining stable line of sight, stable alignment between its components), to its angular orientation;
(ii) the PSS has to be located remotely and/or externally from a center of mass (COM) of the payload

The payload COM is not aligned with the carrier's interface;

The damping center of the damping subsystem of the PSS, or other damping system/device is not aligned with, is remote from and/or is external to the COM of the payload;
(iii) the payload is to be mounted to a carrier which produces forces/oscillations/vibrations/accelerations/shocks; and/or
(iv) the target is remote from the payload and carrier.

One example of such circumstances requiring high stabilization efficiency is a payload including optical/electro-optical equipment designed to transmit/emit and/or detect/measure electromagnetic radiation and therefore requires maintaining a stable LOS orientation (stable direction to which the optical system is to be directed/pointed), at each given moment, where the payload is to be carried by a vehicle such as an aerial/land/naval vehicle that generates forces/oscillations/vibrations/accelerations/shocks as it operates.

In some cases, the payload equipment (often encased by a casing of the payload) also includes inner controllable adjustment equipment that enables adjusting various optical, mechanical, electronical and/or processing functions of the payload equipment such as for adjusting LOS direction, devices' definitions and parameters, equipment orientation, etc.

According to some embodiments, the payload may also include one or more internal damping, stabilization, bearings, suspension and/or gimbaling.

In some cases, the payload COM is not aligned or is external to the center of the external damping performed by the external passive damping subsystem, which may cause moments exerted due to the distance of the damping center from the payload COM, requiring an extremely efficient payload rotation-prevention/reduction to withstand such forces.

Embodiments of the PSS may also enable efficient natural (passive) adjustability to any angular, linear and/or oscillatory movements that may be exerted to and/or caused by the operation of the carrier as the carrier and payload loaded thereto move over/along/within a medium that also introduces external forces causing the carrier to tilt, rotate, turn, further vibrate etc. e.g., when the carrier is driven over a bumpy road, airborne/air flown via a turmoil environment, sails over a wavy sea, etc.

According to some embodiments, the LDS may include at least:
(i) a first translation assembly having at least one first translation set comprising at least:
at least one sliding element such as brackets, fixedly connectable to the first connecting structure; and
at least one guide element such as a guide bar threaded in the brackets or having the sliding element(s) slide thereover/in,
wherein each sliding element or each guide element of the first translation set are linearly moveable in respect to one another only in parallel to the x-axis;
(ii) a second translation assembly having at least one second translation set comprising at least:
at least one sliding element fixedly connected to the first connecting structure; at least one guide element,
wherein the at least one sliding element or at least one guide element are linearly moveable in respect to one another only in parallel to the y-axis; and
a swing device (such as a rotatable frame) rotatably mounted to the at least one guide element of the second translation set such that force vectors Fz exerted in the z-axis direction will be translated into rotation movement of the swing device which causes linear movement of the payload in parallel to z-axis direction.

According to some embodiments, the swing device of each second translation set may also be linearly movable along the at least one guide element thereof, such that the swing device and slidable and guide elements of the second linear translation assembly/set can also convert/translate Fz exerted forces into linear movement of the payload also in parallel to the x-axis direction additionally to enabling its movement in parallel to the z-axis.

The LDS prevents the payload and/or its base from performing any rotational/angular movements in respect to the carrier

For example, if the desired initial payload-carrier angular orientation is such that one surface of the payload is to be maintained parallel to a interface surface of the carrier, the LDS will prevent the tilting of the payload thereby maintain the two surfaces in the same parallel required relative angular orientation as well as prevent the payload from rotating about an axis that is perpendicular to the parallel surfaces.

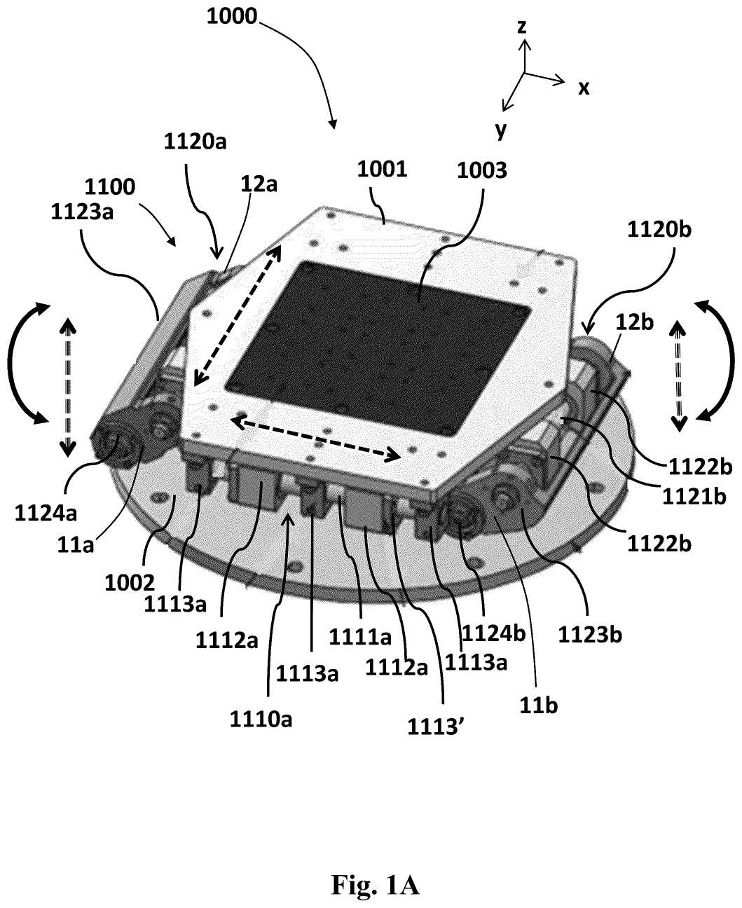

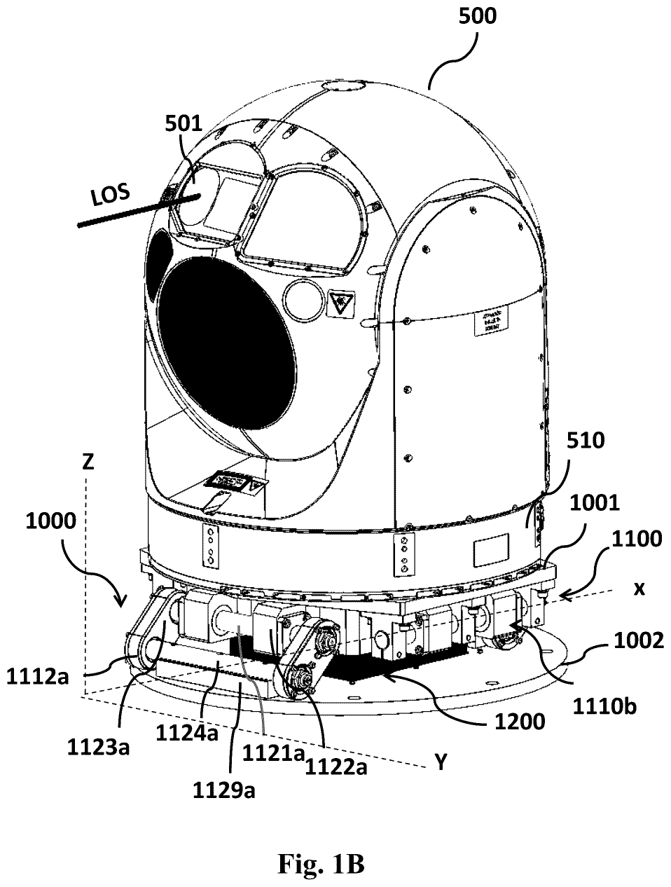

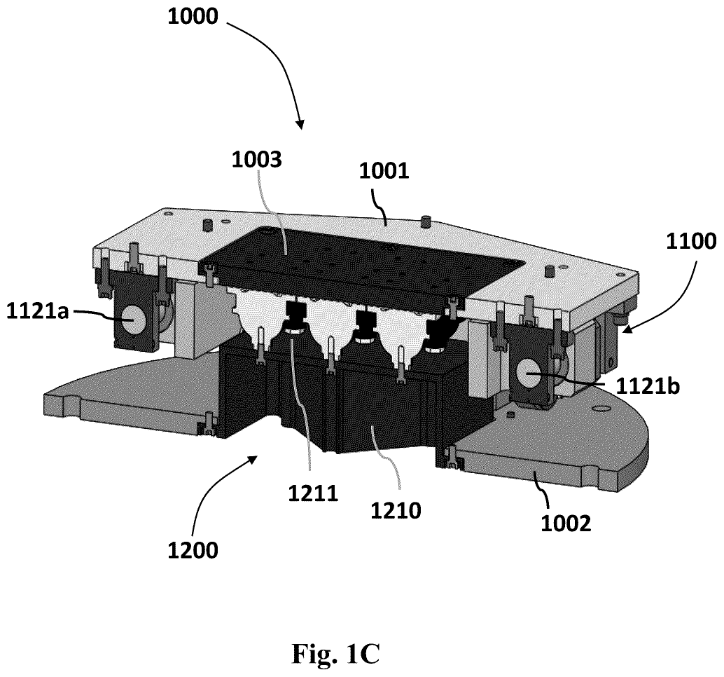

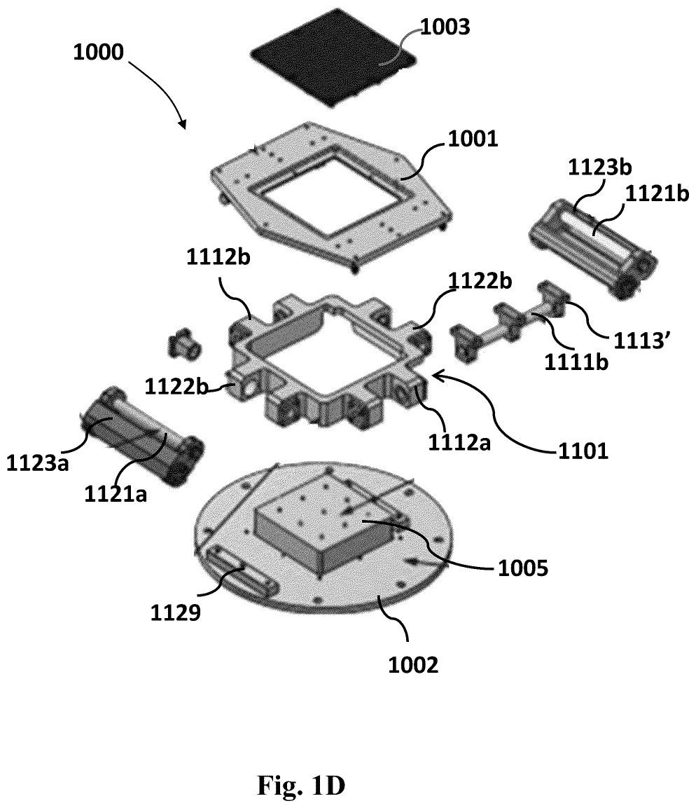

FIGS. 1A-1D, show a PSS 1000 or parts thereof, according to some embodiments, which may include, for example at least:
(i) a first connecting structure, which may include a first plate 1001 fixedly connectable to a payload, optionally in a removable manner;
(ii) a second connecting structure, which may include a second plate 1002 fixedly connectable to a movable/vibratable carrier such as a vehicle or part thereof or a machine or part thereof, optionally in a removable manner; and
(iii) a linear displacement subsystem (LDS) 1100, positioned between the first plate 1001 and the second plate 1002 and configured to translate any exerted angular movements, into separate linear movements of the first plate 1001 and therefore of the payload to which it is connected, inter alia, for reducing/preventing/minimizing responsive tilting of the payload in respect to the carrier, e.g., for maintaining the first plate 1001 in the same angular positioning in respect to the second plate 1002 (such as for maintaining the plates 1001 and 1002 parallel to one another), ultimately for preventing the payload from tilting in respect to the carrier.

As shown in FIGS. 1A-1D, the LDS 1100 of the PSS 1000 may include for example:
(a) a first linear translation assembly including two first linear translation sets 1110a and 1110b positioned in parallel and opposite to one another, the first linear translation assembly being configured to translate Fx force vectors, into linear displacement of the first plate 1001 and the payload connected thereto, only linearly and only in parallel to a first X-axis; and
(b) a second linear translation assembly including two second linear translation sets 1120a and 1120b positioned in parallel and opposite to one another, the second linear translation assembly being configured to translate Fy force vectors, into displacement of the first plate 1001 and the payload connected thereto, only linearly and only in parallel to a second Y-axis, which may be substantially orthogonal to the X-axis, and Fz force vectors, into displacement of the first plate 1001 and the payload connected thereto, only linearly and only in parallel to a third Z-axis and in parallel to the X-axis separately.

Each first linear translation set 1110a/b may include:
a first guide bar 1111a/b;
one or more first payload brackets 1112a/b fixedly connectable to a main frame 1101 of the LDS 1100, from opposite sides thereof; and
one or more first carrier brackets 1113a/b fixedly connectable to the first plate 1001.

According to some embodiments, each of the first payload brackets 1112a/b, the first carrier brackets 1113a/b and optionally also the guide bar 1111a/b may be linearly moveable in respect to the other, in parallel to the X-axis, for conversion of Fx force vectors into linear movement of the first plate 1001 (and payload fixedly connected thereto) in parallel to the X-axis.

Each second linear translation set 1120a/b may include a swing device including at least:
a second guide bar 1121a/b;
one or more second payload brackets 1122a/b fixedly connectable to the main frame 1101 of the LDS 1100; and
a rotatable frame 1123a/b rotatably connectable to its respective second guide bar 1121a/b via the second payload brackets 1123a/b defining a respective rotation axis for each rotatable frame 1123a/b that is parallel to the Y-axis, such that each of the second guide bars 1121a/b can slide within its respective second payload brackets 1122a/b.

According to this configuration, the second linear translation sets 1120a and 1120b of the LDS 1100 are configured to translate a force vector Fy into linear movement of the second payload brackets 1123a/b which may linearly move the first plate 1001 in parallel to the Y-axis, where a force vector Fz will cause each rotatable frame 1123a/b to rotate about its respective rotation axis, which is parallel to the Y-axis, thereby linearly displace the first plate 1001 (and connected payload) in parallel to the Z axis and optionally also cause pushing/pulling of the first plate 1001 (via brackets 1122a/b fixedly connected to the first plate 1001) linearly in parallel to the X-axis (orthogonally to the rotation axis) and cause thereby separate linear displacement of the first plate 1001 and payload connected thereto, in parallel to the X-axis, that is perpendicular to the rotation axis. This means, that any force vector applied in parallel to the Z-axis will cause simultaneous separate linear displacement of the payload both in parallel to the X-axis and the Z-axis.

As shown in FIG. 1B, the swing device of each linear translation set 1120a/b may also include an additional rod 1124a/b engageable with a semi-cylindrical support 1129a/b fixedly connected to the second plate 1002, such that when the second plate 1002 is pushed or pulled by the carrier towards or a way from the first plate 1001 in parallel to the Z-axis, it will rotate the rod 1124a/b in its semi-cylindrical niche support 1129a/b causing the rotatable frame 1123a/b to rotate about its respective second guide bar 1121a/b.

FIG. 1B, shows an example of having a payload 500 that includes equipment such as emission, detection and/or launching equipment that requires maintaining a stable LOS angular direction (payload pointing direction). The payload 500 is fixedly (non-moveably) and optionally removably connected to the first plate 1001, e.g., via a casing and/or a base 510 thereof, where the LOS pointing direction to be stabilized and maintained, is set to project from an opening 501 of the payload 500.

In some cases, the required LOS pointing direction to be maintained can be changeable and adjustable by the payload's 500 inner equipment such that it can be adjusted and fixed to a specific desired direction in respect to the XYZ linear coordinates system of the PSS 1000, at any given moment. The PSS 1000 will enable the adjusted desired LOS, to remain in the same pointing direction (in respect to the XYZ coordinate system that is moveable/rotatable along with the carrier or vehicle carrying the carrier) by only allowing XYZ separate per-axis linear displacement of the payload.

According to some embodiments, the PSS 1000 may further include one or more additional damping subsystems or elements such as a damping subsystem 1200, as shown in FIG. 1C. The damping subsystem 1200 may include one or more dampers/buffers such as dampers 1211, e.g., supported by a support structure 1210 (see FIG. 1C). The dampers 1211 of the damping subsystem 1200 may be located between the platforms 1001 and 1002 of the PSS 1000, inside the LDS 1100, for absorbing/dissipating especially (yet not only) vibrational and shock movements applied to the PSS by the carrier through its connected second plate 1002. The dampers 1211 may be springs and/or made from elastic material(s) such as rubber, silicon based materials such as Silicone Gel, sponge materials and structure, or polymeric elastic materials, enabling energy dissipation by energy absorption and may be also shaped and sized for optimal/improved damping.

According to some embodiments, as shown in FIG. 1C, each damper 1211 may have a tapered shape, where its wider side/base faces the second plate 1002 and its narrower side faces the first plate 1001.

According to some embodiments, as shown in FIG. 1D, the PSS 1000 may further include a vibrations adaptor 1005 engageable with the damping subsystem 1200 and connectable to the second plate 1002.

According to some embodiments as shown in FIGS. 1C and 1D, a covering or supporting plate 1003 may be removably installed, to cover an opening at the first plate 1001, being configured for holding or supporting the dampers 1211.

It can be seen from FIGS. 1A-1D that each guide bar 1111a/1111b/1121a/1121b has a limited sliding span within corresponding bracketing/framing elements 11a, 11b, 12a and 12b along their respective X/Y axes. Therefore, the PSS 1000 design may be configured such that these linear movement spans are adapted to expected forces powers. In case of forces vectors in the X or Y direction that are too powerful, the natural reaction of the guide bars, due to their linear movement span limitations, may be to linearly return in the opposite direction once reaching the border of their respective movement span, e.g., forming a reciprocal linear motion.

In certain embodiment, each plate 1001/1002 may be removably connected to payload/carrier, respectively e.g., via bolts, screws, etc. or irremovably attached to the payload/carrier e.g., by welding thereof to a surface of the payload/carrier.

In certain embodiments, the different components of the PSS 1000 may be made of rigid material(s), which may provide the PSS with a structural rigidity that prevents the PSS's parts form deforming.

The PSS 1000, according to some embodiments, can be used to connect any device/payload to any carrier.

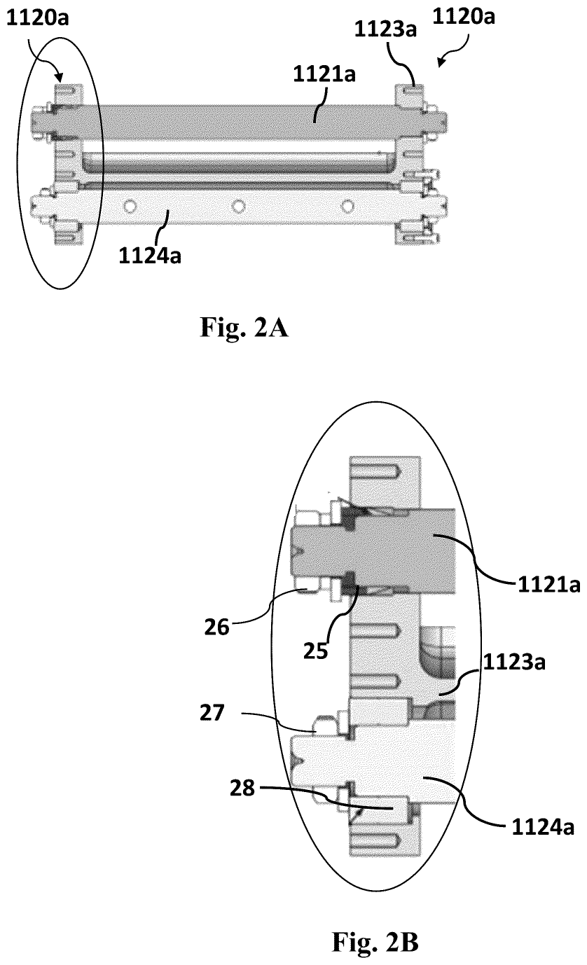

FIGS. 2A-2B show cross sectional views of swing devices of each second linear guide assembly 1120a/1120b of the LDS 1100 of the PSS 1000, according to some embodiments. It can be seen especially from the enlarged cross sectional view of FIG. 2B, that the second guide bar 1121a may be releasably lockable to the rotatable frame 1123a via a locking mechanism such as a Ringfeder® (trademark of RINGFEDER GMBH) 25, for allowing rotation of the guide bar 1121a yet securing it to the rotatable frame 1123a such as to prevent it from sliding outside the edge border of the rotatable frame 1123a, thereby defining limit to the linear sliding span of the first plate 1001 in parallel to the Y-axis. The Ringfeder® 25 may be designed such that an outer portion thereof has a lock element 26 for securing the Ringfeder® 25 to the corresponding edge of the rotatable frame 11231129a and an inner portion thereof (facing the guide bar 1121a can be rotatably coupled/mounted to the corresponding edge of the second guide bar 1121a, enabling free rotation thereof. Each end of the second guide bar 1121a and corresponding rod 1124a may connect to a Ringfeder® portion or have an edge that has protruding and/or recessed links enabling interlocking with another portion of the Ringfeder®.

Additionally or alternatively, the rod 1124a may be secured to another edge of the rotatable frame 1123a via another locking mechanism 27, optionally including an inner bearing ring 28.

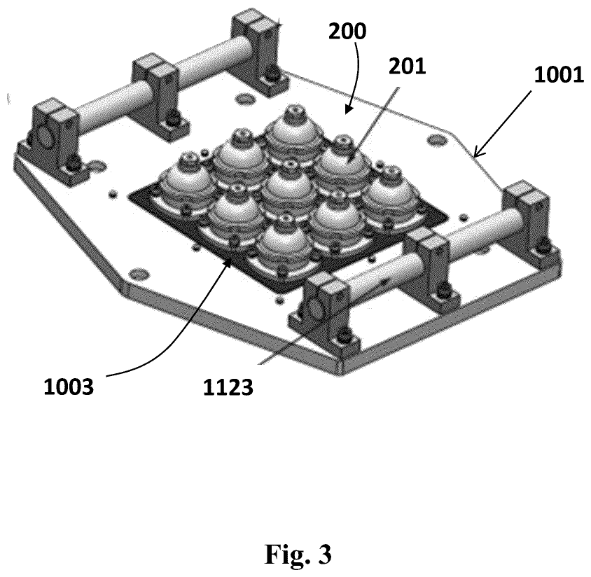

Reference is now made to FIG. 3, showing a schematic illustration of an additional damping subsystem 200 for a PSS 1000, according to some embodiments, for improving shock absorption of the PSS. In these embodiments, the damping subsystem 200 connects to the first plate 1001 of the PSS 1000 via a supporting plate 1003 placed in and/or connected to the first plate 1001. Similar to the damping subsystem 1200 shown in FIG. 1C, this damping subsystem 200 shown in FIG. 3, also includes an array of dampers 201 each damper 201 having a tapered shape, where in this case, the narrower edge of each damper 201 faces the second plate 1002 and the wider base part of the damper 201 faces the inner surface of the first plate 1001.

According to other embodiments, the damping subsystem may be located externally to the LDS, between the two plates 1001 and 1002, such as for example within a peripheral rim space between the plates 1001 and 1002 that is external to the LDS.

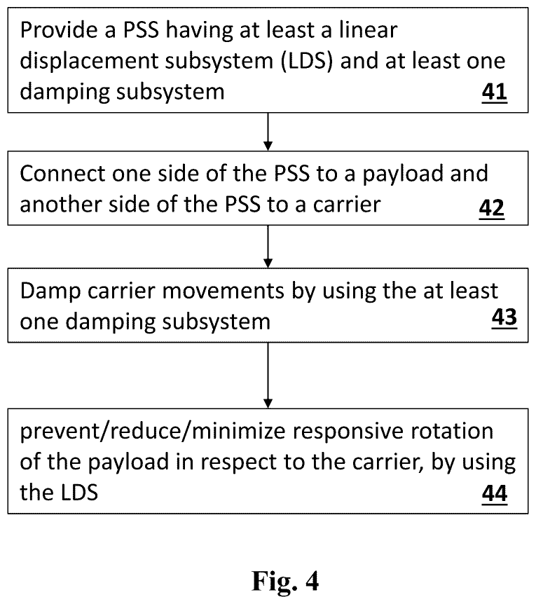

FIG. 4 is a flowchart of a process/method for passive stabilization of a payload, according to some embodiment. The method/process may include:
providing a PSS 41, such as PSS 1000 as described above, including at least the LDS 1100 and at least one damping subsystem such as damping subsystem 1200;
connecting the PSS at one side thereof to the carrier and at another side thereof to a payload, such that the PSS is located between the carrier and the payload 42;
passively damping carrier movements by using the at least one damping subsystem 43; and
passively reducing/preventing/minimizing rotation of the payload in respect to the carrier, by using the LDS 44.

### EXAMPLES

Example 1 is a passive stabilization system (PSS) for stabilizing a payload being carried by a carrier, the PSS comprising at least a linear displacement subsystem (LDS), fixedly connectable to the carrier at one side thereof and fixedly connectable to a payload at another side thereof, such that the LDS is located between the payload and the carrier, wherein the LDS is configured to enable only three-dimensional (3D) linear displacement of the payload in respect to the carrier, for reducing responsive relative angular movement of the payload in respect to the carrier, for maintaining a stable relative angular orientation of the payload in respect to the carrier.

In example 2, the subject matter of example 1 may include, wherein the LDS is configured for separate per-axis linear movement of the payload along three linear orthogonal axes of the LDS coordinate system XYZ.

In example 3, the subject matter of any one or more of examples 1 to 2 may include, wherein the first connecting structure comprises a first plate fixedly and removably connectable to a payload or a carrier and the second connecting structure comprises a second plate fixedly and removably connectable to a carrier or a payload.

In example 4, the subject matter of any one or more of examples 1 to 3 may include, wherein the LDS comprises at least:
(i) a first translation assembly having at least one first translation set, each first translation set comprising at least:
at least one first sliding element fixedly connected to the first connecting structure and at least one other sliding element fixedly connectable to the second connecting structure; and
at least one guide element, wherein the at least one first sliding element is linearly moveable along the guide element in parallel to the x-axis for translating force vectors Fx parallel to the x-axis exerted in the x-axis direction into linear sliding movements of the at least one sliding element fixedly connected to the first connecting structure, in parallel to the x-axis direction, thereby enabling linear movement of the payload in parallel to the x-axis;
(ii) a second translation assembly having at least one second translation set, each second translation set comprising at least:
at least one second sliding element fixedly connected to the first connecting structure; at least one second guide element, wherein the at least one second sliding element is linearly moveable along the at least one guide element in parallel to the y axis, for translating force vectors Fy exerted in the y-axis direction into linear sliding movements of the at least one second sliding element, in parallel to the y-axis; and
at least one rotatable frame mounted to the at least one second guide element of the second translation set such that force vectors Fz exerted in the z-axis direction are translated into rotation movement of the swing device which causes linear movement of the payload at least in parallel to z-axis direction.

In example 5, the subject matter of example 4 may include, wherein the swing device of each second translation set is also linearly movable along the at least one guide element thereof, such that the swing device can also translate Fz exerted forces in the z-axis direction into linear movement of the payload in parallel to the x-axis direction in addition to linear movement in parallel to the z-axis.

In example 6, the subject matter of any one or more of examples 4 to 5 may include, wherein the at least one first sliding element of the first linear translation set comprises one or more first payload brackets fixedly connectable to the first connecting structure, which is connectable to the payload.

In example 7, the subject matter of any one or more of examples 4 to 6 may include, wherein the at least one second sliding element of each second linear translation set comprises one or more second payload brackets fixedly connectable to the first connecting structure, which is connectable to the payload.

In example 8, the subject matter of any one or more of examples 6 to 7 may include, wherein the PSS further includes a main frame comprising brackets connected thereto, wherein the first and second sliding elements are slidably inserted also through the brackets of the main frame.

In example 9, the subject matter of any one or more of examples 1 to 8 may include, wherein the PSS further comprises at least one damping subsystem for damping and/or shock absorption of the carrier's movements/vibrations/accelerations/shocks.

In example 10, the subject matter of example 9 may include, wherein the damping subsystem comprises one or more dampers located between the first connecting structure and the second connecting structure of the PSS.

In example 11, the subject matter of any one or more of examples 1 to 10 may include, wherein the PSS is located externally to the payload.

In example 12, the subject matter of any one or more of examples 1 to 11 may include, wherein the PSS is located remotely from a center of mass (COM) of the payload and/or off-axis from the COM axis of the payload.

Example 13 is a method for stabilizing a payload carried by a carrier, the method comprising at least:
providing a PSS comprising at least a linear displacement subsystem (LDS) and at least one damping subsystem, wherein the LDS is configured to enable only three-dimensional (3D) linear displacements of the payload;
connecting the PSS at one side thereof to the carrier and at another side thereof to a payload, such that the PSS is located between the carrier and the payload; and
damping movements of the carrier by the at least one damping subsystem; and
reducing rotation of the payload in respect to the carrier by using the LDS.

Example 14 is a passive stabilization system (PSS) for stabilizing a payload carried by a carrier, the system comprising at least:
a linear displacement subsystem (LDS), fixedly connectable to the carrier at one side thereof and fixedly connectable to a payload at another side thereof, such that the LDS is located between the payload and the carrier; and
a damping subsystem comprising one or more dampers, wherein the damping subsystem is located and configured to damp movements/vibrations/accelerations/shocks of the carrier and the LDS is configured to prevent/reduce/minimize angular/rotational movements of the payload in respect to the carrier by enabling only a three-dimensional (3D) linear displacement of the payload in respect to the carrier, for maintaining a stable relative angular orientation of the payload in respect to the carrier.

In example 15, the subject matter of example 14 may include, wherein the LDS is configured for separate per-axis linear movement of the payload along three linear orthogonal axes of the LDS coordinate system XYZ.

In example 16, the subject matter of any one or more of examples 14 to 15 may include, wherein each of the one or more dampers of the damping subsystem includes a tapered shape.

In example 17, the subject matter of any one or more of examples 14 to 16 may include, wherein the damping subsystem is located within the LDS between the payload and the carrier.

In example 18, the subject matter of any one or more of examples 14 to 17 may include, wherein the damping subsystem is located externally to the LDS between the payload and the carrier.

It is noted that any terms used in this document should not be construed so as to limit the scope of the present invention. In particular, the words “comprise(s)” and “comprising” are not meant to exclude any elements not specifically stated. Single elements or components may be substituted with multiple elements or components or with their equivalents.

It will be understood by those skilled in the art that the present invention is not limited to the embodiments illustrated above and that many modifications and additions may be made without departing from the scope of the invention as defined in the appending claims.

Notably, structural details of the invention are shown to provide a fundamental understanding of the invention, the description, taken with the drawings, making apparent to those skilled in the art how the several forms of the invention may be embodied in practice.

It is to be understood that the embodiments described hereinabove are cited by way of example, and that the present invention is not limited to what has been particularly shown and described hereinabove. System elements described may be altered according to need and additional known elements of similar systems, which are not explicitly mentioned or exemplified herein, may be added.

While various embodiments have been described above, it should be understood that they have been presented by way of example only, and not limitation. Where methods described above indicate certain events occurring in certain order, the ordering of certain events may be modified. Additionally, certain of the events may be performed concurrently in a parallel process, when possible, as well as performed sequentially as described above. In addition, method steps associated with the system and process can be rearranged and/or one or more such steps can be omitted to achieve the same, or similar, results to those described herein.

It is to be understood that values and relations between objects, elements, parameters, surfaces, spaces etc. discussed above pertain to achievable accuracies of such values or relations. For example, surfaces or elements described as parallel or as maintained parallel pertain to an achievable level of parallelism between those surfaces/elements, angles between axes, elements, surfaces etc. described as orthogonal or perpendicular to one another, pertain to an achievable level of orthogonality between those axes, elements, surface, etc.

1. A passive stabilization system (PSS) for stabilizing a payload being carried by a carrier, the PSS comprising at least:
a linear displacement subsystem (LDS), fixedly connectable to the carrier at one side thereof and fixedly connectable to a payload at another side thereof, such that the LDS is located between the payload and the carrier, wherein the LDS is configured to enable a three-dimensional (3D) linear displacement of the payload in respect to the carrier, for reducing responsive relative angular movements of the payload in respect to the carrier, for maintaining a stable relative angular orientation of the payload in respect to the carrier.

2. The PSS of claim 1, wherein the LDS is configured for separate per-axis linear movement of the payload along three linear orthogonal axes of the LDS coordinate system XYZ.

3. The PSS of claim 1, wherein the first connecting structure comprises a first plate fixedly and removably connectable to a payload or a carrier and the second connecting structure comprises a second plate fixedly and removably connectable to a carrier or a payload.

4. The PSS of claim 1, wherein the LDS comprises at least:
(i) a first translation assembly having at least one first translation set, each first translation set comprising at least:
at least one first sliding element fixedly connected to the first connecting structure and at least one other sliding element fixedly connectable to the second connecting structure; and
at least one guide element,
wherein the at least one first sliding element is linearly moveable along the guide element in parallel to the x-axis for translating force vectors Fx parallel to the x-axis exerted in the x-axis direction into linear sliding movements of the at least one sliding element fixedly connected to the first connecting structure, in parallel to the x-axis direction, thereby enabling linear movement of the payload in parallel to the x-axis;
(ii) a second translation assembly having at least one second translation set, each second translation set comprising at least:
at least one second sliding element fixedly connected to the first connecting structure;
at least one second guide element,
wherein the at least one second sliding element is linearly moveable along the at least one guide element in parallel to the y-axis, for translating force vectors Fy exerted in the y-axis direction into linear sliding movements of the at least one second sliding element, in parallel to the y-axis; and
at least one rotatable frame mounted to the at least one second guide element of the second translation set such that force vectors Fz exerted in the z-axis direction are translated into rotation movement of the swing device which causes linear movement of the payload at least in parallel to z-axis direction.

5. The PSS of claim 4, wherein the swing device of each second translation set is also linearly movable along the at least one guide element thereof, such that the swing device can also translate Fz exerted forces in the z-axis direction into linear movement of the payload in parallel to the x-axis direction in addition to linear movement in parallel to the z-axis.

6. The PSS of claim 4, wherein the at least one first sliding element of the first linear translation set comprises one or more first payload brackets fixedly connectable to the first connecting structure, which is connectable to the payload.

7. The PSS of claim 4, wherein the at least one second sliding element of each second linear translation set comprises one or more second payload brackets fixedly connectable to the first connecting structure, which is connectable to the payload.

8. The PSS of claim 6 further comprising a main frame comprising brackets connected thereto, wherein the first and second sliding elements are slidably inserted also through the brackets of the main frame.

9. The PSS of claim 1 further comprising at least one damping subsystem for damping and/or shock absorption of the carrier's movements.

10. The PSS of claim 9, wherein the damping subsystem comprises one or more dampers located between the first connecting structure and the second connecting structure of the PSS.

11. The PSS of claim 1, wherein the PSS is located externally to the payload.

12. The PSS of claim 1, wherein the PSS is located remotely from a center of mass (COM) of the payload and/or off-axis from the COM axis of the payload.

13. A method for stabilizing a payload carried by a carrier, the method comprising at least:
providing a PSS comprising at least a linear displacement subsystem (LDS) and at least one damping subsystem, wherein the LDS is configured to enable three-dimensional (3D) linear displacement of the payload;
connecting the PSS at one side thereof to the carrier and at another side thereof to a payload, such that the PSS is located between the carrier and the payload;
damping movements of the carrier by the at least one damping subsystem; and
reducing rotation of the payload in respect to the carrier by using the LDS.

14. A passive stabilization system (PSS) for stabilizing a payload carried by a carrier, the system comprising at least:
a linear displacement subsystem (LDS), fixedly connectable to the carrier at one side thereof and fixedly connectable to a payload at another side thereof, such that the LDS is located between the payload and the carrier; and
a damping subsystem comprising one or more dampers, wherein the damping subsystem is located and configured to damp movements of the carrier and the LDS is configured to reduce angular movements of the payload in respect to the carrier by enabling only a three-dimensional (3D) linear displacement of the payload in respect to the carrier, for maintaining a stable relative angular orientation of the payload in respect to the carrier.

15. The PSS of claim 14, wherein the LDS is configured for separate per-axis linear movement of the payload along three linear orthogonal axes of the LDS coordinate system XYZ.
